(19) United States
(12) Patent Application Publication
(10) Pub. No.: US 2007/0149713 A1
(43) Pub. Date: Jun. 28, 2007

(54) Soft vinyl chloride copolymer resin, resin composition and process for preparing the same

(75) Inventors: Mitsuyoshi Kuwahata, Hyogo (JP); Kisaburo Noguchi, Hyogo (JP); Toshihito Kawauchi, Hyogo (JP); Yukio Higashiyama, Shiga (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Kanaeka Corporation, Osaka (JP)

(21) Appl. No.: 10/583,991

(22) PCT Filed: Dec. 14, 2004
(86) PCT No.: PCT/JP04/18990

§ 371 Date: Jun. 22, 2006

(51) Int. Cl. C08F 263/00; C08F 289/00

(52) U.S. Cl. 525/244; 526/344

(57) ABSTRACT

The present invention is to provide a novel soft vinyl chloride resin which can has suitable hardness or flexibility in accordance with its various applications, and which has polymerization stability equivalent to that of vinyl chloride and has good transparency and heat resistance. The present invention is attained by a soft vinyl chloride copolymer resin obtained by copolymerizing (A) a vinyl chloride type monomer and (B) a macromonomer having a polymer comprising an ethylenically unsaturated monomer containing a double bond in a main chain, wherein the ratio of (A)/(B) by weight is 50/50 to 80/20.

### TECHNICAL FIELD

The present invention relates to a novel copolymer of a vinyl chloride type monomer and a macromonomer having a polymer comprising an ethylenically unsaturated monomer containing a double bond in a main chain. More specifically, the present invention relates to a novel soft vinyl chloride resin which has satisfactory flexibility with a reduced amount of a plasticizer or without a plasticizer used therein and which has good transparency and good heat-decomposing resistance, and to a process for preparing thereof.

### BACKGROUND ART

Vinyl chloride resin has been used for many applications since it has good mechanical properties and chemical properties and can give hard through soft molded articles by adjusting the amount of a plasticizer used therein.

In particular, regarding vinyl chloride resin used for soft material applications, hardness and flexibility thereof can be controlled by adjusting the amount of a plasticizer used therein. Therefore, vinyl chloride resin is widely used in various fields, for example, for extrusion molding applications such as cable coating, for sheet and film applications such as synthetic leathers, for injection molding applications such as soft molded articles, and for other various applications.

These days, however, the influence of plasticizer on the environment and living bodies such as some harmful influence on human bodies is much discussed. Given that situation, therefore, much desired is a novel technique for imparting suitable hardness or flexibility to resin in accordance with various applications thereof.

When a vinyl chloride/vinyl acetate copolymer resin prepared by copolymerizing a vinyl chloride type monomer with a vinyl acetate monomer is used as a soft resin, the copolymerization ratio of the monomers is high and what is called a random copolymer is thereby formed, and therefore, the glass transition temperature of the copolymer can be lowered and the copolymer may have good flexibility. However, there is a problem that the heat resistance of the copolymer is extremely lowered and the processing temperature range of the copolymer is still narrow even when a stabilizer is used along with it (Progress in Polymer Science, 2002, Vol. 27, p. 2037).

Known are a technique of internal plasticization by graft-polymerizing a vinyl chloride polymer with an acrylic ester monomer having a low glass transition temperature (JP-A-55-021424); and a technique of improving impact resistance by graft-polymerizing an acrylic ester monomer containing a polyfunctional monomer with a vinyl chloride type monomer (JP-A-60-255813). However, when the vinyl chloride polymer is merely partially grafted in the presence of a peroxide catalyst or a reaction residue of a polyfunctional monomer, the reaction gives a three-phase mixture of a vinyl chloride homopolymer, an acrylic ester homopolymer and a small amount of a graft polymer, and therefore there is a problem that the polymer mixture alone can hardly give a soft resin that has transparency and heat-decomposing resistance.

From the viewpoint of transportation by air flow, the resin is often desired to have high bulk specific gravity and good powdery flowability. Regarding the particle form of the resin for the above purpose, it is desired that the friction between the resin particles is small and the surface roughness of the particles is low.

For the purpose of increasing bulk specific gravity of resin, disclosed are a method of adding a monomer to the reaction system during polymerization reaction to thereby lower the molecular weight of the polymer in the particle interfaces (JP-A-59-168008); and a method of using partially-saponified polyvinyl alcohols having a different polymerization degree and a different saponification degree as a dispersant to form resin particles (JP-A-09-241308). However, these methods still have a problem in point of the surface roughness (Ra) of the resin particles prepared, and, in addition, the improvement in the powdery flowability of the resin particles is still unsatisfactory.

### DISCLOSURE OF INVENTION

An object of the present invention is to provide a novel soft vinyl chloride resin which may have suitable hardness or flexibility in accordance with various applications thereof, and which has polymerization stability equivalent to that of a vinyl chloride resin and has good transparency and heat-decomposing resistance.

The present inventors have assiduously studied, and, as a result, have found that the above-mentioned object can be attained by using a macromonomer in which molecular weight distribution and polymerizable reactive groups are controlled. On the basis thereof, the present invention has been completed.

Specifically, the present invention relates to the following:

(1) A soft vinyl chloride copolymer resin obtained by copolymerizing (A) a vinyl chloride type monomer and (B) a macromonomer having a polymer comprising an ethylenically unsaturated monomer containing a double bond in a main chain, wherein the ratio by weight of (A)/(B) is 50/50 to 80/20;

(2) The soft vinyl chloride copolymer resin, wherein the macromonomer having a polymer comprising an ethylenically unsaturated monomer containing a double bond in a main chain has a polymerizable reactive group, and the polymerizable reactive group has a structure containing at least one group represented by the the following general formula per one molecule:
—OC(O)C(R)═CH₂ (1)
wherein R represents a hydrogen atom, or an organic group having 1 to 20 carbon atoms;

(3) The soft vinyl chloride copolymer resin, wherein the macromonomer having a polymer comprising an ethylenically unsaturated monomer containing a double bond in a main chain is prepared by living radical polymerization;

(4) The soft vinyl chloride copolymer resin, wherein at least one of the macromonomers having a polymer comprising an ethylenically unsaturated monomer containing a double bond in a main chain have a glass transition temperature of at most 0° C.;

(5) A process for preparing the soft vinyl chloride copolymer resin, which comprises polymerizing a vinyl chloride type monomer and a macromonomer having a polymer comprising an ethylenically unsaturated monomer containing a double bond in a main chain by at least one process selected from emulsion polymerization, suspension polymerization and microsuspension polymerization;

(6) A soft vinyl chloride composition comprising the above soft vinyl chloride copolymer resin.

According to the present invention, a vinyl chloride type monomer and a macromonomer having a polymer comprising an ethylenically unsaturated monomer containing a double bond in a main chain are grafted at a high ratio during polymerization reaction, at high productivity. The soft vinyl chloride copolymer resin of the present invention may have good and satisfactory flexibility even when the amount of the plasticizer used therein is reduced or even when the resin contains no plasticizer. In addition, the soft vinyl chloride copolymer resin of the present invention has good heat-decomposing resistance.

### BRIEF DESCRIPTION OF DRAWING

FIG. 1 is an outline view of a funnel used in powder flowability evaluation.

### BEST MODE FOR CARRYING OUT THE INVENTION

The vinyl chloride type monomer used in the present invention is not specifically limited. For example, herein usable are a vinyl chloride monomer, vinylidene chloride monomer, vinyl acetate monomer or a mixture thereof, or in addition, a monomer which is copolymerizable therewith and preferably gives no reactive functional group to the main chain of the polymer prepared by polymerization reaction, for example, one selected from α-olefins such as ethylene and propylene, or a mixture of at least two kinds of them. When a mixture of at least two kinds is used, it is preferable that the vinyl chloride monomer content based on the entire vinyl chloride type monomer is at least 50% by weight and more preferably at least 70% by weight, and even more preferably, the content is at least 90% by weight since the intended soft copolymer resin is easy to obtain.

A macromonomer is generally an oligomer having a reactive functional group at the terminal thereot. The macromonomer having a polymer comprising an ethylenically unsaturated monomer containing a double bond in a main chain, which is used in the present invention, is prepared by radical polymerization, and has at least one group having a polymerizable carbon-carbon double bond selected from an allyl group, vinylsilyl group, vinyl ether group, dicyclopentadienyl group and the following general formula (1) per one molecule at the terminal of the molecule, as a reactive functional group.

In particular, the group having a polymerizable carbon-carbon double bond is preferably represented by the following general formula:
—OC(O)C(R)═CH₂ (1)
as its reactivity with a vinyl chloride type monomer is good.

In the formula, concrete examples of R are not specifically limited. For example, R is preferably selected from —H, —CH₃, —CH₂CH₃, —(CH₂)ₙCH₃ (where n indicates an integer of 2 to 19), —C₆H₅, —CH₂OH and —CN; and more preferably, —H or —CH₃.

The polymer comprising an ethylenically unsaturated monomer containing a double bond, which is the main chain of the macromonomer used in the present invention, is prepared by radical polymerization. Radical polymerization is classified into “general radical polymerization” in which a monomer having a specific functional group and a vinyl monomer are simply copolymerized using an azo compound or a peroxide as a polymerization initiator; and “controlled radical polymerization” in which a specific functional group can be introduced into a controlled position such as a terminal of a polymer.

In “general radical polymerization”, a monomer having a specific functional group cannot be introduced into a polymer only at random, and therefore, when a polymer having a high functionalization is desired to be obtained, a relatively large quantity of the monomer need to be used. In addition, since “general radical polymerization” is free radical polymerization, molecular weight distribution of the polymer obtained is so broad that it is difficult to obtain a polymer having low viscosity.

“Controlled radical polymerization” can be further classified into “chain transfer polymerization” in which a chain transfer agent having a specific functional group is used for polymerization to give a vinyl polymer having a functional group at the terminal thereof, and “living radical polymerization” in which a polymer having a molecular weight approximately designed is obtained by growing a polymerization growth end without causing a termination reaction etc.

“Chain transfer polymerization” makes it possible to obtain a polymer having a high functionalization degree, but requires a chain transfer agent having a specific functional group for an initiator. In addition, “chain transfer polymerization” is also free radical polymerization like the above-mentioned “general radical polymerization”, and therefore molecular weight distribution of the polymer obtained is so broad that it is difficult to obtain a polymer having low viscosity.

Differing from these polymerization processes, “living radical polymerization” is radical polymerization which is said to be difficult to control as polymerization speed is so high that termination reaction readily occurs due to coupling of radicals etc., as described in the international publication WO 99/65963 relating to the invention by the present applicant. However, “living radical polymerization” hardly undergoes termination reaction, and it readily gives a polymer having a narrow molecular weight distribution, for example, having a ratio of weight average molecular weight Mw to number average molecular weight Mn (Mw/Mn) of 1.1 to 1.5 or so, and, in addition, the molecular weight of a polymer can be freely controlled depending on the charging ratio of the monomer and the initiator charged.

Accordingly, in such “living radical polymerization”, since a polymer having a narrow molecular weight distribution and a low viscosity can be obtained and additionally since a monomer having a specific functional group can be introduced into almost any position of the polymer obtained, “living radical polymerization” is a more preferable polymerization process for preparing the above-mentioned vinyl polymer having a specific functional group in the present invention.

Among “living radical polymerization”, “Atom Transfer Radical Polymerization: ATRP” in which a vinyl monomer is polymerized in the presence of an organic halide or a sulfonyl halide compound as an initiator and a transition metal complex as a catalyst, is further preferable for preparing a vinyl polymer having a specific functional group since “atom transfer radical polymerization” has characteristics in that a polymer used has a halogen etc., which is relatively advantageous for functional group conversion reaction, at its terminal and latitude in designing an initiator and a catalyst is large, in addition to the characteristics of “living radical polymerization” mentioned above. For atom transfer radical polymerization, for example, referred to is Matyjaszewski et al., Journal of American Chemical Society, 1995, Vol. 117, p. 5614.

Any of the above-mentioned processes may be employed with no specific limitation for preparing the macromonomer in the present invention. In general, however, controlled radical polymerization is utilized, and living radical polymerization is preferred as it facilitates reaction control therein. Most preferred is atom transfer radical polymerization.

The process for preparing the macromonomer in the present invention is not specifically limited, however, generally employed is controlled radical polymerization. Living radical polymerization is preferable in view of easiness of controlling the reaction, and most preferable is atom transfer radical polymerization. The macromonomer having a polymer comprising an ethylenically unsaturated monomer containing a double bond in a main chain, which is prepared by controlled radical polymerization, specifically by living radical polymerization, can be completely copolymerized with a vinyl chloride resin at its terminal, and is therefore preferable since the surface roughness of the polymer particles to be prepared can be reduced by modifying the monomer composition in the vinyl chloride type monomer droplets or around the interface thereof. Another advantage of the macromonomer is that the copolymer to be obtained can have good flexibility, and also good transparency and heat resistance.

The polymer comprising ethylenically unsaturated monomer containing a double bond, which the main chain of the macromonomer used in the present invention has, is not specifically limited, and various types of polymers may be employed for an ethylenically unsaturated monomer containing a double bond which constitutes the polymer.

Specifically, the monomer is meant to include (meth)acrylic acid monomers; styrene monomers; fluorine-containing vinyl monomers; silicon-containing vinyl monomers; maleimide monomers; nitrile group-containing vinyl monomers; amide group-containing vinyl monomers; vinyl esters; alkenes; conjugated dienes; maleic anhydride, maleic acid, monoalkyl esters and dialkyl esters of maleic acid; fumaric acid, monoalkyl esters and dialkyl esters of fumaric acid; allyl chloride and allyl alcohol.

For example, the monomer includes (meth)acrylic acid monomers such as (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl)trimethoxysilane, ethylene oxide adducts of (meth)acrylic acid, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate; styrene monomers such as styrene, vinyltoluene, α-methylstyrene, chlorostyrene, styrenesulfonic acid and salts thereof; fluorine-containing vinyl monomers such as perfluoroethylene, perfluoropropylene, vinylidene fluoride; silicon-containing vinyl monomers such as vinyltrimethoxysilane, vinyltriethoxysilane; maleic anhydride, maleic acid, monoalkyl ester and dialkyl ester of maleic acid; fumaric acid, monoalkyl ester and dialkyl ester of fumaric acid; maleimide monomers such as maleimide, methylmaleimide, ethylmaleimide, propylmaleimide, butylmaleimide, hexylmaleimide, octylmaleimide, dodecylmaleimide, stearylmaleimide, phenylmaleimide, cyclohexylmaleimide; nitrile group-containing vinyl monomers such as acrylonitrile, methacrylonitrile; amide group-containing vinyl monomers such as acrylamide, methacrylarnide; vinyl esters such as vinyl acetate, vinyl propionate, vinyl pivalate, vinyl benzoate, vinyl cinnamate; alkenes such as ethylene, propylene; conjugated dienes such as butadiene, isoprene; allyl chloride, allyl alcohol. These may be used alone, or two or more of these may be copolymerized. Among these, preferred are vinyl acetate monomers and (meth)acrylic acid monomers in view of the physical properties of the products. More preferred are acrylic ester monomers and methacrylic ester monomers; even more preferred are acrylic ester monomers; and most preferred is n-butyl acrylate. The wording “(meth)acrylic acid” is meant to indicate methacrylic acid or acrylic acid. When two or more monomers are copolymerized, it is desirable that these preferred monomers are used at an amount of at least 40% by weight of the entire macromonomer.

The macromonomer copolymerizable with a vinyl chloride type monomer in the present invention can be used alone, or two kinds or more of macromonomers in which ethylenically unsaturated monomers constituting the macromonomers are different may be used in a combination.

Regarding the glass transition temperature of the macromonomer having a polymer comprising an ethylenically unsaturated monomer containing a double bond in a main chain, in the present invention, in the case where one macromonomer is used alone or at least two kinds thereof are used in a combination, it is desirable that at least one macromonomer used herein has a glass transition temperature of at most 0° C., more preferably at most −20° C., most preferably at most −50° C. When two or more macromonomers are used in a combination, it is desirable that the macromonomer having a grass transition temperature of at most −50° C. is used at an amount of at least 50% by weight among all the macromonomers.

The number average molecular weight of the macromonomer used in the present invention, which has a polymer comprising an ethylenically unsaturated monomer containing a double bond in a main chain, is not specifically limited. Preferably, however, the weight average molecular weight of the macromonomer, as measured by gel permeation chromatography (hereinafter abbreviated to GPC), is 500 to 100,000, more preferably between 3,000 and 40,000, most preferably between 3,000 and 20,000. When the macromonomer falling within the range is used, the macromonomer can be uniformly mixed with a vinyl chloride type monomer and can give a stable aqueous polymer after the polymerization reaction. The macromonomer having a molecular weight of not less than 500 is preferred from the viewpoint that the amount of the unreacted macromonomer still remaining after the polymerization is small. The macromonomer having a molecular weight of not more than 100,000 is also preferred from the viewpoint that, though its viscosity may be high, the macromonomer may fully dissolve in a vinyl chloride type monomer and does not almost interfere with its copolymerization.

The ratio of a weight average molecular weight (Mw) to a number average molecular weight (Mn) thereof measured by GPC (Mw/Mn) is preferably less than 1.8, more preferably at most 1.6, even more preferably at most 1.4. The macromonomer having a molecular weight distribution of less than 1.8 is preferable since polymerization may go on stably to give polymer particles having a reduced surface roughness; and the macromonomer having a molecular weight distribution of at most 1.4 is more preferable since fluctuation of interface tension of vinyl chloride type monomer droplets is so small that stable and uniform polymer particles having a surface of good condition can be prepared.

Measurement by GPC in the present invention was conducted at room temperature using a Waters' GPC system (Model No. 510), wherein chloroform is used as the mobile phase and also Shodex K-802.5 and K-804 (polystyrene gel columns) available from Showa Denko K.K. are used.

Preferably, the soft vinyl chloride copolymer resin of the present invention is a copolymer obtained by copolymerizing (A) a vinyl chloride type monomer and (B) a macromonomer having a polymer comprising an ethylenically unsaturated monomer containing a double bond in a main chain in the ratio by weight [(A)/(B)] of 80% by weight/20% by weight to 50% by weight/50% by weight. The vinyl chloride copolymer resin falling within the range may exist as a stable polymer during and after the polymerization, and the copolymer resin thus prepared can have enough flexibility.

More preferably, the ratio of (A)/(B) in the soft vinyl chloride copolymer resin of the present invention is 80% by weight/20% by weight to 60% by weight/40% by weight. The advantages of the resin falling within the range are that the surface roughness (Ra) of the resin particles is small, the bulk specific gravity thereof is high and the powdery flowability thereof is good.

The average polymerization degree and the average molecular weight of the soft vinyl chloride copolymer resin of the present invention are not specifically limited. Like that of vinyl chloride resins prepared and used in an ordinary manner, the K value of the soluble content of the resin, as measured according to JIS K 7367-2 (ISO 1628-2), is 50 to 95.

There is no specific limitation on the process for preparing the soft vinyl chloride copolymer resin of the present invention. Aqueous polymerization is preferred from the viewpoint that the polymerization control is easy, a dry resin can be obtained in the form of a granular powder and the handling property of the resin obtained is good. For example, aqueous polymerization includes emulsion polymerization, suspension polymerization and microsuspension polymerization. More preferred are suspension polymerization and microsuspension polymerization in view of the easiness in controlling the polymer particles prepared and the easiness in drying thereof.

The vinyl chloride polymer resin of the present invention may be used either in the form of an aqueous dispersion or a dried resin powder. Preferably, it is used in the form of a dried resin powder as its handling property is good.

The weight average particle size of the aqueous dispersion of the vinyl chloride polymer resin of the present invention is not specifically limited, but preferably is 0.01 to 500 μm, more preferably 0.1 to 250 μm, even more preferably 1 to 200 μm. The vinyl chloride polymer resin falling within the range is preferable since the aqueous dispersion thereof exhibits good polymerization stability.

The method for drying the aqueous dispersion of the vinyl chloride polymer resin is not specifically limited, and vinyl chloride polymer resin powder is obtained, for example, by a method that an aqueous dispersion after polymerization is subjected to centrifugal dewatering and then dried in a fluidized bed, a method that dewatered resin is jet into steam and collected using a dust collector such as a cyclone, or a method that resin dispersion is dried into powder using a double-flow nozzle or an atomizer.

The vinyl chloride resin powder is an aggregated dried article of single or multiple particles that are prepared by heating an aqueous dispersion of a vinyl chloride polymer to remove as much water content as possible therefrom. The particle size of the vinyl chloride polymer resin powder is not specifically limited, and is 10 μm to 1000 μm, preferably 20 μm to 500 μm, more preferably 30 μm to 200 μm. The vinyl chloride polymer resin powder falling within the range is desirable since its powdery flowability is good.

In suspension polymerization, suspension dispersants to be used are not specifically limited, and examples are organic polymer compounds such as partially-saponified poly(vinyl acetate), methyl cellulose, hydroxypropylmethyl cellulose, carboxymethyl cellulose, poly(ethylene oxide), poly(vinylpyrrolidone), poly(acrylic acid), vinyl acetate/maleic acid copolymer, styrene/maleic acid copolymer, gelatin, starch; and water insoluble inorganic fine particles such as calcium sulfate or tricalcium phosphate. These can be used alone or two kinds or more can be used in a combination.

In microsuspension polymerization or emulsion polymerization, surfactants to be used are not specifically limited, and examples are anionic surfactants such as alkylsulfate ester salts, alkylarylsulfonate salts, sulfosuccinate salts, fatty acid salts, polyoxyethylene alkylarylsulfate ester salts, polyoxyethylene alkylsulfate ester salts (herein, “salts” refer to potassium salts, sodium salts, ammonium salts, etc.) and hydrophilic nonionic surfactants such as sorbitan esters, polyoxyethylene alkyl ethers, polyoxyethylene alkylphenyl ethers and polyoxyethylene alkyl esters. These can be used alone or two kinds or more can be used in a combination. As a dispersion aid, examples are higher alcohols, higher fatty acids and esters thereof, aromatic hydrocarbons, higher aliphatic hydrocarbons, halogenated hydrocarbons, water-soluble polymers. One kind or more may be used.

In suspension polymerization or microsuspension polymerization utilized for preparing the vinyl chloride copolymer resin of the present invention, oil-soluble polymerization initiators may be added. Among these initiators, one kind or two kinds or more of the initiators having a temperature at which the half are reduced in 10 hours of 30 to 65° C. are preferably used.

It is desirable that the polymerization initiator is soluble in the monomer to be polymerized. Such polymerization initiators include 2,2′-azobisisobutyronitrile, 2,2′-azobis-(2,4-dimethylvaleronitrile), 2,2′-azobis-4-methoxy-2,4-dimethylvaleronitrile, and other azo or diazo polymerization initiators; and benzoyl peroxide, methyl ethyl ketone peroxide, isopropyl peroxycarbonate, and other organic peroxide polymerization initiators. These can be used alone or two kinds or more can be used in a combination. These oil-soluble polymerization initiators may be added to the reaction system in a manner with no specific limitation. For example, when an oil-soluble polymerization initiator is used to be dissolved in an organic solvent, examples of the organic solvent are aromatic hydrocarbons such as toluene, xylene and benzene; aliphatic hydrocarbons such as hexane and isoparaffin; ketones such as acetone and methyl ethyl ketone; and esters such as ethyl acetate, butyl acetate and dioctyl phthalate. These can be used alone or two kinds or more can be used in a combination.

In addition, antioxidant, polymerization degree-controlling agent, chain transfer agent, particle size-controlling agent, pH-controlling agent, gellation improver, antistatic agent, stabilizer and scale inhibitor that are generally used in preparation of ordinary vinyl chloride resin may also be used optionally without any limitation at an arbitrary amount.

Other vinyl chloride resins may be used as combined with no specific limitation, if desired, with the soft vinyl chloride copolymer resin composition of the present invention. Further if desired, plasticizer, filler, heat stabilizer, flame retardant, lubricant, antistatic agent, reinforcing agent, modifier and pigment may be added to the composition.

The soft vinyl chloride copolymer resin of the present invention is internally plasticized to a full extent without a plasticizer, and therefore the resin can form a soft molded article at room temperature even when used alone. However, any other vinyl chloride resin may be added thereto to obtain a soft resin composition. When some other vinyl chloride resins are used in a combination with the resin of the present invention, it is desirable that among the resin composition comprising the soft vinyl chloride resin and the additional vinyl chloride resin, the additional vinyl chloride resin is preferably used at an amount of 0 to 50% by weight, more preferably 0 to 30% by weight.

When the soft vinyl chloride copolymer resin is combined with an additional vinyl chloride resin, the method of mixing thereof is not specifically limited, and examples are a method of mixing in a dry state, and a method of mixing in the form of aqueous resin dispersions and then drying the resulting mixture to obtain a resin.

For controlling the flexibility of the soft vinyl chloride polymer resin composition, a plasticizer may be optionally added to the composition. For example, usable are one or at least two kinds of plasticizers selected from phthalic acid ester plasticizers such as di-2-ethylhexyl phthalate (DOP), di-n-octyl phthalate, diisononyl phthalate (DINP), dibutyl phthalate (DBP); phosphoric acid ester plasticizers such as tricresyl phosphate (TCP), trixylyl phosphate (TXP), triphenyl phosphate (TPP); fatty acid ester plasticizers such as di-2-ethylhexyl adipate (DEHA), di-2-ethylhexyl sebacate; and polyacrylic plasticizers such as poly(butyl acrylate), n-butyl acrylate/methyl methacrylate copolymer, 2-ethylhexyl acrylate/methyl methacrylate copolymer, 2-ethylhexyl acrylate/methyl methacrylate/n-butyl methacrylate copolymer. Regarding the amount of the plasticizer, no plasticizer may be added to the soft vinyl chloride copolymer resin of the present invention when the resin is used alone so as not to lower the transparency of the molded articles thereof. In general, however, the amount of the plasticizer used is preferably 0 to 100 parts by weight, more preferably 0 to 70 parts by weight, most preferably 0 to 50 parts by weight based on 100 parts by weight of the vinyl chloride resin comprising the soft vinyl chloride resin and an additional vinyl chloride resin in order to control the desired flexibility of the vinyl chloride polymer resin composition.

A heat stabilizer may be optionally added for controlling the thermal stability of the soft vinyl chloride copolymer resin composition. Such heat stabilizer includes, for example, organic tin stabilizers such as dimethyltin mercaptide, dibutyltin mercaptide, dioctyltin mercaptide, dibutyltin maleate, dibutyltin maleate polymer, dioctyltin maleate, dioctyltin maleate polymer, dibutyltin laurate, dibutyltin laurate polymer; lead stabilizers such as lead stearate, dibasic lead phosphite, tribasic lead sulfate; calcium-zinc stabilizers; barium-zinc stabilizers; cadmium-barium stabilizers. These can be used alone or two kinds or more can be used in a combination. The amount thereof to be used is not specifically limited, but is preferably 0 to 5 parts by weight based on 100 parts by weight of the vinyl chloride resin comprising the soft vinyl chloride resin and an additional vinyl chloride resin.

The stabilization aid is not specifically limited, and examples are epoxidized soybean oil, epoxidized linseed oil, epoxidized tetrahydrophthalate, epoxidized polybutadiene and phosphoric esters. These can be used alone or two kinds or more can be used in a combination, and the amount thereof to be used is not specifically limited.

The filler is not also specifically limited, and includes, for example, calcium carbonate, magnesium carbonate, lithium carbonate, kaolin clay, gypsum, mica, talc, magnesium hydroxide, calcium silicate and borax. The amount of filler is not specifically limited and is within a suitable range for transparent applications through for a reinforcing agent, and in general, it is desirable that the amount is 0 to 500 parts by weight, more preferably 0 to 200 parts by weight, most preferably 0 to 100 parts by weight based on 100 parts by weight of the vinyl chloride resin comprising the soft vinyl chloride resin and an additional vinyl chloride resin.

The process for preparing the vinyl chloride copolymer resin composition of the present invention is not specifically limited, and the vinyl chloride copolymer resin composition of the present invention is prepared, for example, by the process, wherein the vinyl chloride copolymer resin of the present invention and any other optional vinyl chloride resin are compounded at a predetermined amount, and further optionally other additives (e.g., heat stabilizer, lubricant, stabilization aid, processing aid, filler, antioxidant, light stabilizer, pigment and plasticizer) are added thereto; thereby these are uniformly mixed in an ordinary manner such as hot blending or cold blending using a mixing machine such as a Henschel mixer. Herein, the order of mixing the components is not specifically limited. For example, the vinyl chloride polymer resin and the optional additives are mixed all at one time, or the vinyl chloride polymer resin and various powdery additives are previously mixed, and then liquid additives are added thereto for the purpose of compounding liquid additives uniformly mixed.

The method for molding the vinyl chloride copolymer resin composition thus-prepared into various molded articles is not specifically limited, and examples are ordinary methods of molding vinyl chloride resin such as extrusion molding, injection molding, calender molding, press molding, etc.

### EXAMPLES

The present invention is explained in detail with reference to the following Examples, to which, however, the present invention should not be limited. Unless otherwise specifically indicated, “part” and “%” in the Examples mean “part by weight” and “% by weight”, respectively.

<Presence or Absence of Yield Point Under Tension, Time for Initial Coloration by Heating; Measurement and Evaluation of Surface Tackiness>

(A) Presence or Absence of Yield Point Under Tension:

Resins were compounded, and rolled and pressed into a sheet, and the obtained sheet was stamped out to give a No. 2 dumbbell test piece according to JIS K7113. Presence or absence of a yield point regarding the test piece was confirmed at a pulling rate of 50 mm/min.

The yield point is as follows: When 5% depression was seen after the maximum stress in the stress-strain curve drawn in the tensile test, it was judged that the test piece had yielded at the maximum stress applied thereto.

It is generally known that soft molded articles do not have a yield point.

(B) Time for Initial Coloration by Heating:

Resins were compounded, and rolled and pressed into a sheet, and the obtained sheet was cut into a test piece having a size of 3 cm×4 cm according to JIS K7212. The test piece was put into a gear oven (No. 102-SHF-77 available from Yasuda Seiki Seisakusho, LTD.) set at 190° C. and heated therein under the condition that aging was HIGH, the damper was entirely closed, and drum rotation was ON. Time required for the sample to become opaque and black as a whole by visual observation was measured.

It was judged that the sample taking a longer heating time had better thermal stability.

(C) Surface Tackiness:

Resins were compounded, and rolled and pressed into a sheet, and the surface thereof was touched with fingers at room temperature to judge the presence or absence of tacky feeling.

It was judged that the sample having tacky feeling had high surface tackiness.

<Evaluation of Mean Particle Size, Bulk Specific Gravity, Surface Roughness and Powdery Flowability>

Mean particle size, bulk specific gravity, surface roughness and powdery flowability of resin samples were evaluated according to the following methods.

(D) Mean Particle Size

The resins obtained in Example 9 and Comparative Examples 5 and 6 were analyzed as follows: The resin was left under the condition of 23° C./50% RH for 24 hours. According to JIS K 6720-2 (ISO 1060-2), the resin was screened through sieves having an opening size of 355 μm, 250 μm, 180 μm, 150 μm, 125 μm, 106 μm and 75 μm under the condition of 23° C./50% RH, using a full-automatic acoustic screen classifier (Model: Robot Shifter RPS-85 available from Seishin Enterprise Co., Ltd.), and the 50%-passed sieve size was assumed to be a weight average particle size (μm) of the sample.

The resins obtained in Example 10 and Comparative Examples 7 and 8 were analyzed as follows: After the polymerization, the resultant slurry or latex was left under the condition of 23° C./50% RH for 24 hours, and then was measured under the condition of 23° C./50% RH, using MULTISIZER II available from Coulter Electronics Ltd. The particle size at the cumulative weight distribution of 50% was assumed to be a weight average particle size of the sample.

(E) Bulk Specific Gravity

Bulk specific gravity of the sample was determined according to JIS K 6720-2 (ISO 1060-2).

(F) Surface Roughness of Particles (Ra)

The resins obtained in Examples 9 and 10 and Comparative Examples 5 to 8 were analyzed as follows: The resin was left under the condition of 23° C./50% RH for 24 hours. According to the surface roughness definition described in JIS B 0601 (ISO 4287), the resin was evaluated by means of measuring an arithmetic mean surface roughness Ra (μm) of the surface of several tens of resin particles, then calculating the average thereof, under the condition of 23° C./50% RH, using an ultra-deep color three-dimensional profile analyzing microscope (Model: VK-9501 available from KEYENCE CORPORATION).

(G) Powdery Flowability:

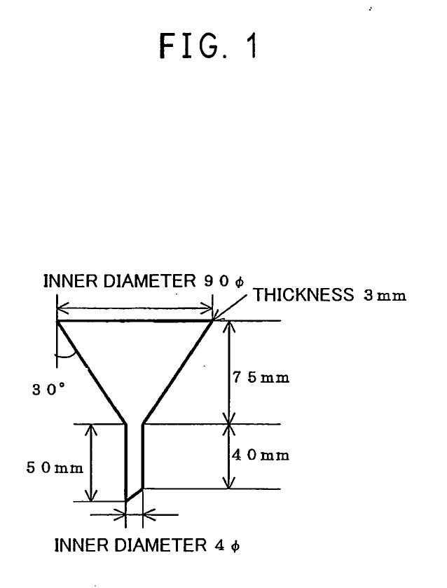

The resins obtained in Example 9 and Comparative Examples 5 and 6 were analyzed as follows: The resin was left under the condition of 23° C./50% RH for 24 hours. Under the condition of 23° C./50% RH, the mouth of a funnel shown in FIG. 1 was sealed up with a stopper, and 100 ml of the resin analyzed according to the bulk specific garavity measuring method described in JIS K6720-2 (ISO 1060-2) was put into the funnel. After the resin was completely put into the funnel, the stopper was removed from the mouth of the funnel, and the time t (sec) required for the resin totally to drop off was measured. From the time, t and the weight, W (g) of 100 ml of the resin, the weight of the resin that dropped per a unit of time; W/t (g/sec) was calculated, and the value obtained was used for the index of the powdery flowability of the sample.

The resins obtained in Example 10 and Comparative Examples 7 and 8 were analyzed as follows: The resin was left under the condition of 23° C./50% RH for 24 hours. 100 g of the resin was put on a JIS standard sieve having an opening size of 250 μm fixed on a KM-shaker (Model: V-SX available from Iwaki Sangyo Co., Ltd.). A 50 g weight was fixed to one end of a 30 cm string in such a manner that the weight hit the side of the sieve. The weight was made to freely drop from the position of the angle of 60° against the vertical face, and the operation was repeated 30 times. The weight (g) of the resin having passed through the sieve was measured.

<Preparation of Macromonomer Having a Polymer Comprising an Ethylenically Unsaturated Monomer Containing a Double Bond in a Main Chain>

The macromonomer having at least one vinyl polymer as its structural component was prepared according to the process mentioned below. The number average molecular weight of the macromonomer prepared was calculated in terms of polystyrene measured through GPC, and the molecular weight distribution thereof was calculated as the ratio of the weight average molecular weight to the number average molecular weight similarly in terms of polystyrene. Measurement by GPC was conducted under the condition of 23° C. and a humidity ratio of 50% using a Waters' GPC system (Model No. 510), wherein tetrahydrofuran was used as the mobile phase and also Shodex K-802.5 and K-804 (polystyrene gel columns) available from Showa Denko K.K. were used.

### Preparation Example 1

CuBr (5.54 g) was put into a 2-liter separable flask equipped with a reflux tube and a stirrer, and the inside of the reactor was purged with nitrogen. Acetonitrile (73.8 ml) was added thereto, and stirred in an oil bath at 70° C. for 30 minutes. N-butyl acrylate (132 g), methyl 2-bromopropionate (7.2 ml) and pentamethyldiethylenetriamine (4.69 ml) were added thereto, and the reaction was initiated. While stirring with heat at 70° C., n-butyl acrylate (528 g) was continuously and dropwisely added ovdr 90 minutes, and further stirred with heat for 80 minutes.

The reaction mixture was diluted with toluene, and passed through an active alumina column, and then the volatiles were evaporated away under reduced pressure to obtain poly(n-butyl acrylate) having a Br group at one end.

Methanol (800 ml) was fed into a flask and cooled to 0° C. Potassium t-butoxide (130 g) was divided into a few portions and added intermittently. The reaction solution was kept at 0° C., and a methanol solution of acrylic acid (100 g) was dropwisely added thereto. After the addition, the reaction solution was restored from 0° C. to room temperature, and the volatiles were evaporated away therefrom under reduced pressure to obtain potassium acylate (CH₂═CHCO₂K).

The obtained poly(n-butyl acrylate) having a Br group at one end (150 g), potassium acrylate (7.45 g) and dimethylacetamide (150 ml) were put into a 500-ml flask equipped with a reflux tube, and stirred with heat at 70° C. for 3 hours. Dimethylacetamide was evaporated away from the reaction mixture, and the residue was dissolved in toluene and passed through an active alumina column. Then, toluene was evaporated away to obtain a poly(n-butyl acrylate) macromonomer having an acryloyl group at one end. The number average molecular weight of the macromonomer was 12,000 and the molecular weight distribution was 1.11.

### Preparation Example 2

A poly(n-butyl acrylate) macromonomer having an acryloyl group at one end having a number average molecular weight of 6,000 and a molecular weight distribution of 1.14 was obtained in the same manner as in Preparation Example 1, except that the amount of methyl-2-bromopropionate used in Preparation Example 1 was 14.4 ml.

<Preparation of Vinyl Chloride Copolymer Resins>

Vinyl chloride polymer resins were prepared according to the process mentioned below.

### Example 1

A 35-liter pressure vessel was purged with N₂, and then well degassed. The poly(butyl acrylate) having an acryloyl group at one end of Preparation Example 1 (3.0 kg), and a vinyl chloride monomer (7.0 kg) were put into the vessel and pre-stirred for 60 minutes. Next, α,α′-azobis-2,4-dimethylvaleronitrile (12.0 g) and t-butyl peroxyneodecanoate (2.1 g) were added thereto. An aqueous emulsifier solution (20.0 kg) in which stearyl alcohol (31.7 g), cetyl alcohol (43.0 g) and sodium laurylsulfate (66.4 g) were dissolved in advance, was added to the vessel, and homogenized for 30 minutes to obtain a monomer dispersion. The inside of the vessel was kept at 50° C., and the polymerization was initiated. When the pressure in the reactor began to lower after 8 hours, the unreacted vinyl chloride monomer in the polymerization reactor was recovered, the inside of the vessel was cooled, and the resultant latex was collected (The conversion ratio of the vinyl chloride monomer was about 90%.).

The latex was dried with a double-flow nozzle spray drier (inlet 110° C./outlet 50° C.) to obtain a powdery vinyl chloride/poly(butyl acrylate) graft copolymer resin (TP30). The K value of the soluble content of the resin, measured according to JIS K7367-2 (ISO 1628-2), was 70.

500 g of the resin was powder-blended with 2.5 g of a higher alcohol (KALCOL 86 available from Kao Corporation) as a lubricant, 2.5 g of an ester lubricant (PH18 available from Riken Vitamin Co., Ltd.), and 2.0 g of TVS#8813 and 5.0 g of TVS#8831 (both are an octyl Sn stabilizer available from NITTO KASEI Co., Ltd.), and then rolled and pressed (roll temperature: 180° C., 5 min; press temperature: 185° C., 10 min) to obtain a test sheet having a thickness of 1 mm. The resin (TP30) did not have an yield point, which meant that the resin was a soft resin. The resin took a long time for initial coloration by heating and was transparent and was not tacky (sticky) on its surface. The results are shown in Table 1.

### Example 2

A vinyl chloride/poly(butyl acrylate) graft copolymer resin (TP40) was obtained in the same manner as in Example 1, except that 4.0 kg of the poly(butyl acrylate) having an acryloyl group at one end in Example 1 and 6.0 kg of a vinyl chloride monomer were used.

The K value of the soluble content of the resin, measured according to JIS K7367-2 (ISO 1628-2), was 70.

500 g of the resin was powder-blended with 2.5 g of higher alcohol (KALCOL 86 available from Kao Corporation) as a lubricant, 2.5 g of an ester lubricant (PH18 available from Riken Vitamin Co., Ltd.), and 2.0 g of IVS#8813 and 5.0 g of TVS#8831 (both are an octyl Sn stabilizer available from NITTO KASEI Co., Ltd.), and then rolled and pressed (roll temperature: 180° C., 5 min; press temperature: 185° C., 10 min) to obtain a test sheet having a thickness of 1 mm. The resin (TP40) did not have an yield point, which meant that the resin was a soft resin. The resin took a long time for initial coloration by heating and was transparent and was not tacky (sticky) on its surface. The results are shown in Table 1.

### Example 3

A vinyl chloride/poly(butyl acrylate) graft copolymer resin (TP40-82) was obtained in the same manner as in Example 2, except that the polymerization temperature was 35° C. and the polymerization time was 12 hours.

The K value of the soluble content of the resin, measured according to JIS K7367-2 (ISO 1628-2), was 82.

500 g of the resin was powder-blended with 2.5 g of higher alcohol (KALCOL 86 available from Kao Corporation) as a lubricant, 2.5 g of an ester lubricant (PH18 available from Riken Vitamin Co., Ltd.), and 2.0 g of TVS#8813 and 5.0 g of TVS#8831 (both are an octyl Sn stabilizer available from NITTO KASEI Co., Ltd.), and then rolled and pressed (roll temperature: 180° C., 5 min; press temperature: 185° C., 10 min) to obtain a test sheet having a thickness of 1 mm.

The resin (TP40-82) did not have an yield point, which meant that the resin was a soft resin. The resin took a long time for initial coloration by heating and was transparent and was not tacky (sticky) on its surface. The results are shown in Table 1.

### Example 4

A vinyl chloride/poly(butyl acrylate) graft copolymer resin (TP50) was obtained in the same manner as in Example 1, except that 5.0 kg of the poly(butyl acrylate) having an acryloyl group at one end in Example 1 and 5.0 kg of a vinyl chloride monomer were used.

The K value of the soluble content of the resin, measured according to JIS K7367-2 (ISO 1628-2), was 70.

500 g of the resin was powder-blended with 2.5 g of higher alcohol (KALCOL 86 available from Kao Corporation) as a lubricant, 2.5 g of an ester lubricant (PH18 available from Riken Vitamin Co., Ltd.), and 2.0 g of TVS#8813 and 5.0 g of TVS#8831 (both are an octyl Sn stabilizer available from NITTO KASEI Co., Ltd.), and then rolled and pressed (roll temperature: 180° C., 5 min; press temperature: 185° C., 10 min) to obtain a test sheet having a thickness of 1 mm.

The resin (TP50) did not have an yield point, which meant that the resin was a soft resin. The resin took a long time for initial coloration by heating and was transparent and was not tacky (sticky) on its surface. The results are shown in Table 1.

### Example 5

500 g of the resin obtained by the preparation process of Example 2 (TP40) was powder-blended with 2.5 g of higher alcohol (KALCOL 86 available from Kao Corporation) as a lubricant, 2.5 g of an ester lubricant (PH18 available from Riken Vitamin Co., Ltd.), and 0 g of TVS#8813 and 2.5 g of TVS#8831 (both are an octyl Sn stabilizer available from NITTO KASEI Co., Ltd.), and then rolled and pressed (roll temperature: 180° C., 5 min; press temperature: 185° C., 10 min) to obtain a test sheet having a thickness of 1 mm.

The resin having reduced amount of an octyl Sn stabilizer took almost the same time for initial coloration by heating. The resin took a long time for initial coloration by heating and was transparent and was not tacky (sticky) on its surface. The results are shown in Table 1.

### Example 6

500 g of the resin obtained by the preparation process of Example 4 (TP50) was powder-blended with 2.5 g of higher alcohol (KALCOL 86 available from Kao Corporation) as a lubricant, 2.5 g of an ester lubricant (PH18 available from Riken Vitamin Co., Ltd.), and 0 g of TVS#8813 and 1.0 g of TVS#8831 (both are an octyl Sn stabilizer available from NITTO KASEI Co., Ltd.), and then rolled and pressed (roll temperature: 180° C., 5 min; press temperature: 185° C., 10 min) to obtain a test sheet having a thickness of 1 mm.

The resin having reduced amount of an octyl Sn stabilizer took almost the same time for initial coloration by heating. The resin took a long time for initial coloration by heating and was transparent and was not tacky (sticky) on its surface. The results are shown in Table 1.

### Example 7

50 g of DOP as a plasticizer was added to 500 g of a resin mixture of 250 g of the resin obtained by the preparation process of Example 2 (TP40) and 250 g of a vinyl chloride homopolymer resin (S1003 available from KANEKA CORPORATION), and then the resin mixture was powder-blended with 2.5 g of higher alcohol (KALCOL 86 available from Kao Corporation) as a lubricant, 2.5 g of an ester lubricant (PH18 available from Riken Vitamin Co., Ltd.), and 2.0 g of TVS#8813 and 5.0 g of TVS#8831 (both are an octyl Sn stabilizer available from NITTO KASEI Co., Ltd.), thereafter rolled and pressed (roll temperature: 180° C., 5 min; press temperature: 185° C., 10 min) to obtain a test sheet having a thickness of 1 mm.

The resin in which a vinyl chloride homopolymer resin in a combination did not have an yield point, which meant that the resin obtained was a soft resin. The resin took a long time for initial coloration by heating and was transparent and was not tacky (sticky) on its surface. The results are shown in Table 1.

### Example 8

0.05 part of partially-saponified polyvinyl alcohol having a saponification degree of about 80 mol % and an average polymerization degree of about 2,000, 0.005 part of polyethylene oxide having an average molecular weight of about 4,500,000, 0.03 part of t-butyl peroxyneodecanoate, and 0.01 part of 1,1,3,3-tetramethylbutyl peroxyneodecanoate were fed into a 25-liter stainless steel polymerization reactor equipped with a jacket and a stirrer. After degassing the reactor, 60 parts of a vinyl chloride monomer and 40 parts of the poly(n-butyl acrylate) macromonomer having an acryloyl group at one end of Preparation Example 1 were fed thereinto. Next, 120 parts of hot water at 60° C. was fed thereinto, and polymerization was conducted at a polymerization temperature of 57° C. for about 6 hours. The unreacted monomer in the polymerization reactor was recovered, the reactor was cooled, and the resultant slurry was collected. (The conversion of the vinyl chloride monomer was about 90%).

The thus obtained slurry was dewatered and dried with a hot air drier at 55° C. for 24 hours to obtain a vinyl chloride polymer resin powder (TS40). The K value of the soluble content of the resin, measured according to JIS K7367-2 (ISO 1628-2), was 67.

500 g of the resin was powder-blended with 2.5 g of higher alcohol (KALCOL 86 available from Kao Corporation) as a lubricant, 2.5 g of an ester lubricant (PH18 available from Riken Vitamin Co., Ltd.), and 2.0 g of TVS#8813 and 5.0 g of TVS#8831 (both are an octyl Sn stabilizer available from NITTO KASEI Co., Ltd.), and then rolled and pressed (roll temperature: 180° C., 5 min; press temperature: 185° C., 10 min) to obtain a test sheet having a thickness of 1 mm. The resin (TP40) did not have an yield point, which meant that the resin was a soft resin. The resin took a long time for initial coloration by heating and was transparent and was not tacky (sticky) on its surface. The results are shown in Table 1.

### Example 9

The resin powder L obtained in Example 8 was analyzed in point of mean particle size, bulk specific gravity, surface roughness and powdery flowability. The results are shown in Table 2.

### Example 10

80 parts of a vinyl chloride monomer, 20 parts of the poly(n-butyl acrylate) macromonomer having an acryloyl group at one end of Preparation Example 2, 0.03 part of t-butyl peroxyneodecanoate, 0.12 part of hydroxypropylmethyl cellulose having a methoxyl group content of 21%, a hydroxypropoxyl group content of 8% and a viscosity as 2% aqueous solution at 20° C. of 30,000 mPa·s, 0.13 part of sodium dodecylbenzenesulfonate and 160 parts of degassed pure water were put into a 20-liter pressure vessel that had been fully degassed and purged with nitrogen. While stirring, the inside of the vessel was kept heated at 54.5° C., and the polymerization was initiated. When the pressure in the vessel began to lower after about 5 hours, the monomer in the polymerization reactor was recovered, the inside of the vessel was cooled, and the resultant slurry was collected (The conversion ratio of the vinyl chloride monomer was about 90%.). After dewatered through centrifugation, the slurry was dried with being fluidized at 60° C. to obtain a vinyl chloride polymer resin powder O.

The resin powder O thus obtained was evaluated in point of mean particle size, bulk specific gravity, surface roughness and powdery flowability. The results are shown in Table 3.

### Comparative Example 1

A 1 mm-thick test sheet was produced in the same manner as in Example 1 by rolling and pressing operation (roll temperature: 200° C., 5 min; press temperature: 210° C., 10 min), except that a vinyl chloride homopolymer resin (S1003) was used in place of TP30 in Example 1.

The sample showed an yield point before broken by pulling. Time for initial coloration by heating was 40 minutes, which was shorter than the resin samples of Examples. The results are shown in Table 1.

### Comparative Example 2

In Comparative Example 1, 200 g of a plasticizer DOP was added to the resin, and the resin was powder-blended with 2.5 g of higher alcohol (KALCOL 86 available from Kao Corporation) as a lubricant, 2.5 g of an ester lubricant (PH18 available from Riken Vitamin Co., Ltd.), and 2.0 g of TVS#8813 and 5.0 g of TVS#8831 (both are an octyl Sn stabilizer available from NITTO KASEI Co., Ltd.), and then rolled and pressed (roll temperature: 180° C., 5 min; press temperature: 185° C., 10 min) to obtain a 1 mm-thick test sheet.

Time for initial coloration by heating was 90 minutes, which was shorter than the resin samples of Examples. Though the sheet was transparent, it was tacky (sticky). The results are shown in Table 1.

### Comparative Example 3

In Comparative Example 1, 400 g of a plasticizer DOP was added to the resin, and the resin was powder-blended with 2.5 g of higher alcohol (KALCOL 86 available from Kao Corporation) as a lubricant, 2.5 g of an ester lubricant (PH18 available from Riken Vitamin Co., Ltd.), and 2.0 g of TVS#8813 and 5.0 g of TVS#8831 (both are an octyl Sn stabilizer available from NITTO KASEI Co., Ltd.), and then rolled and pressed (roll temperature: 180° C., 5 min; press temperature: 185° C., 10 min) to obtain a 1 mm-thick test sheet.

Time for initial coloration by heating was 90 minutes, which was shorter than the resin samples of Examples. Though the sheet was transparent, it was tacky (sticky). The results are shown in Table 1.

### Comparative Example 4

A 1 mm-thick test sheet was produced in the same manner as in Example 1 by rolling and pressing operation (roll temperature: 180° C., 5 min; press temperature: 185° C., 10 min), except that a vinyl chloride/vinyl acetate copolymer resin (M1008 available from KANEKA CORPORATION, vinyl acetate content of 7%) was used in place of TP30 in Example 1.

Time for initial coloration by heating was 20 minutes, which was shorter than the resin samples of Examples. The results are shown in Table 1.

### Comparative Example 5

45 parts of a vinyl chloride monomer and 55 parts of the poly(n-butyl acrylate) macromonomer having an acryloyl group at one end in Preparation Example 2 were polymerized in the same manner as in Example 9.

The polymerization speed was low and when the inside of the polymerization reactor was checked after the vinyl chloride monomer was recovered, the contents aggregated as a whole and resin was not formed.

### Comparative Example 6

99.98 parts of a vinyl chloride monomer and 0.02 part of the poly(n-butyl acrylate) macromonomer having an acryloyl group at one end of Preparation Example 1 was polymerized, dewatered and dried in the same manner as in Example 9 to obtain a vinyl chloride polymer resin powder P.

The resin powder P thus obtained was evaluated in point of mean particle size, bulk specific gravity, surface roughness and powdery flowability. The results are shown in Table 2. As compared with the products prepared in Example 9, the product obtained herein had a larger surface roughness, its bulk specific gravity was low and its powdery flowability was poor.

### Comparative Example 7

45 parts of a vinyl chloride monomer and 55 parts of the poly(n-butyl acrylate) macromonomer having an acryloyl group at one end in Preparation Example 2 were polymerized in the same manner as in Example 10.

The polymerization speed was low and when the inside of the polymerization reactor was checked after the vinyl chloride monomer was recovered, the contents aggregated as a whole and resin was not formed.

### Comparative Example 8

99.98 parts of a vinyl chloride monomer and 0.02 part of the poly(n-butyl acrylate) macromonomer having an acryloyl group at one end of Preparation Example 1 were polymerized, dewatered and dried in the same manner as in Example 10 to obtain a vinyl chloride polymer resin powder Q.

The resin powder Q thus obtained was evaluated in point of mean particle size, bulk specific gravity, surface roughness and powdery flowability. The results are shown in Table 3. As compared with the products prepared in Example 10, the product obtained herein had a larger surface roughness, its bulk specific gravity was low and its powdery flowability was poor.

TABLE 1

| | Example | Example | Example | Example | Example | Example | Example | Example |
|---|---|---|---|---|---|---|---|---|
| | 1 | 2 | 3 | 4 | 5 | 6 | 7 | 8 |
| TP30 | 100 | | | | | | | |
| TP40 | | 100 | | | 100 | | 50 | |
| TP40-82 | | | 100 | | | | | |
| TP50 | | | | 100 | | 100 | | |
| TS40 | | | | | | | | 100 |
| PVC (S1003) | | | | | | | 50 | |
| M1008 | | | | | | | | |
| Plasticizer | | | | | | | 10 | |
| Octyl Sn stabilizer 1 | 0.4 | 0.4 | 0.4 | 0.4 | 0 | 0 | 0.4 | 0.4 |
| Octyl Sn stabilizer 2 | 1.0 | 1.0 | 1.0 | 1.0 | 0.5 | 0.2 | 1.0 | 1.0 |
| Presence or absence of | none | none | none | none | none | none | none | none |
| yield point under tension | | | | | | | | |
| Time for initial coloration | 100 | 110 or | 110 or | 110 or | 110 or | 110 or | 100 | 110 or |
| by Heating (min) | | more | more | more | more | more | | more |
| Surface Tackiness | none | none | none | none | none | none | none | none |

| | Comparative | Comparative | Comparative | Comparative |
|---|---|---|---|---|
| | Example 1 | Example 2 | Example 3 | Example 4 |
| TP30 | | | | |
| TP40 | | | | |
| TP40-82 | | | | |
| TP50 | | | | |
| TS40 | | | | |
| PVC (S1003) | 100 | 100 | 100 | |
| M1008 | | | | 100 |
| Plasticizer | | 40 | 80 | |
| Octyl Sn stabilizer 1 | 0.4 | 0.4 | 0.4 | 0.4 |
| Octyl Sn stabilizer 2 | 1.0 | 1.0 | 1.0 | 1.0 |
| Presence or absence of | exist | none | none | none |
| yield point under tension | | | | |
| Time for initial coloration | 40 | 90 | 90 | 20 |
| by heating (min) | | | | |
| Surface tackiness | none | detected | detected | none |

* TP30: BA macromonomer 30 parts added, PVC K value 70.
* TP40: BA macromonomer 40 parts added, PVC K value 70.
* TP40-82: BA macromonomer 40 parts added, PVC K value 82.
* TP50: BA macromonomer 50 parts added, PVC K value 70.
* TS40: BA macromonomer 40 parts added, PVC K value 67.
* M1008: vinyl chloride-vinyl acetate copolymer available from KANEKA CORPORATION, having a vinyl acetate content of 7% and a K value of 62.
* Plasticizer: DOP.
* Octyl Sn stabilizer 1: TVS#8813 by NITTO KASEI Co., Ltd.
* Octyl Sn stabilizer 2: TVS#8831 by NITTO KASEI Co., Ltd.
<1> Tensile Test: According to JIS-K7113, No. 2 dumbbell test piece was employed. The pulling rate was 50 mm/min. The definition of “yield point under tension” is as follows: When 5% depression is seen after the maximum stress in the stress-displacement curve drawn in the tensile test, it was judged that the sample had yielded at the maximum stress applied thereto.
<2> Time for initial coloration by heating: Time required for the resin to become black by visual observation according to JIS-K7212
<3> Surface Tackiness: The sample sheet was touched with fingers at room temperature, presence or absence of tacky feeling of the sample was judged.

TABLE 2

| | | Compar- | Compar- |
|---|---|---|---|
| | | ative | ative |
| | Exam- | Exam- | Exam- |
| | ple 9 | ple 5 | ple 6 |
| Vinyl chloride monomer (% by weight) | 60 | 45 | 99.98 |
| Macromonomer (% by weight) | 40 | 55 | 0.02 |
| Weight average particle size (μm) | 146 | aggre- | 130 |
| Bulk specific gravity (g/ml) | 0.67 | gated | 0.52 |
| Particle surface roughness Ra (μm) | 6.0 | | 11.2 |
| Powdery flowability W/t (g/sec) | 3.11 | | 1.93 |

TABLE 3

| | | Compar- | Compa- |
|---|---|---|---|
| | | ative | rative |
| | Exam- | Exam- | Exam- |
| | ple 10 | ple 7 | ple 8 |
| Vinyl chloride monomer (% by weight) | 80 | 45 | 99.98 |
| Macromonomer (% by weight) | 20 | 55 | 0.02 |
| Weight average particle size (μm) | 42 | aggre- | 40 |
| Bulk specific gravity (g/ml) | 0.65 | gated | 0.45 |
| Particle surface roughness Ra (μm) | 0.22 | | 0.40 |
| Powdery flowability (g) | 93 | | 70 |

### INDUSTRIAL APPLICABILITY

Applications of the soft vinyl chloride copolymer resin of the present invention is not specifically limited as long as the copolymer resin of the present invention can be used therefor. For example, the applications include agricultural films, sheets for general use and agricultural use, soft extruded articles used for gaskets, hoses, tubes and cut-off walls, synthetic leathers, wall paper, stretch films, shrink films, gaskets, hoses, tubes, soles, cable coatings, siding materials, canvases, tapes, mats and the like. As applications for paste resins, examples thereof are wallpapers for mechanical embossing, chemical embossing or rotary screen printing; floor materials such as cushion floors or tile carpets; undercoats, sealants, leathers, canvases, vinyl chloride steel plates and the like.

1. A soft vinyl chloride copolymer resin obtained by copolymerizing (A) a vinyl chloride type monomer and (B) a macromonomer having a polymer comprising an ethylenically unsaturated monomer containing a double bond in a main chain, wherein the ratio of (A)/(B) by weight is 50/50 to 80/20.

2. The soft vinyl chloride copolymer resin of claim 1, wherein the macromonomer having a polymer comprising an ethylenically unsaturated monomer containing a double bond in a main chain has a polymerizable reactive group, and said polymerizable reactive group has a structure containing at least one group represented by the following general formula per one molecule:
—OC(O)C(R)═CH₂ (1)
wherein R represents a hydrogen atom, or an organic group having 1 to 20 carbon atoms.

3. The soft vinyl chloride copolymer resin of claim 1, wherein the macromonomer having a polymer comprising an ethylenically unsaturated monomer containing a double bond in a main chain is prepared by living radical polymerization.

4. The soft vinyl chloride copolymer resin of claim 1, wherein at least one of the macromonomers having a polymer comprising an ethylenically unsaturated monomer containing a double bond in a main chain has a glass transition temperature of at most 0° C.

5. A process for preparing the soft vinyl chloride copolymer resin of claim 1, which comprises polymerizing a vinyl chloride type monomer and a macromonomer having a polymer comprising an ethylenically unsaturated monomer containing a double bond in a main chain by at least one process selected from emulsion polymerization, suspension polymerization and microsuspension polymerization.

6. A soft vinyl chloride resin composition comprising the soft vinyl chloride copolymer resin of claim 1.
